(19) United States
(12) Patent Application Publication
(10) Pub. No.: US 2008/0299223 A1
(43) Pub. Date: Dec. 4, 2008

(54) FORMULATIONS AND USE OF CHLORATE TO REDUCE PATHOGENS IN FOOD AND LIVESTOCK

(76) Inventors: William R. HENNING, Boalsburg, PA (US); Drew A. Vermeire, Lake Saint Louis, MO (US)

Correspondence Address: REED SMITH LLP, P.O. BOX 488, PITTSBURGH, PA, 15230-0488, US

(21) Appl. No.: 12/133,352

(22) Filed: Jun. 4, 2008

Related U.S. Application Data
(60) Provisional application No. 60/941,782, filed on Jun. 4, 2007.

(51) Int. Cl. A01N 59/00; A23L 3/358; A01P 1/00; A23B 4/24

(52) U.S. Cl. 424/662; 426/335; 426/332

(57) ABSTRACT

Processes and formulations using chlorate for the control of pathogenic bacteria in food and livestock. At least one formulation includes sodium chlorate in a concentration effective against E. coli and Salmonella, and is used as a rinsing/washing agent to wash fruits and vegetables, poultry products and livestock facilities.

### CROSS-REFERENCE TO RELATED APPLICATION

This application claims the benefit under 35 U.S.C. § 119(e) of the earlier filing date of U.S. Provisional Application Ser. No. 60/941,782 filed on Jun. 4, 2007.

### FIELD OF INVENTION

The invention relates generally to processes and formulations for the control of pathogens and more particularly to processes and formulations using chlorate for the control of pathogenic bacteria in food and livestock.

### BACKGROUND OF THE INVENTION

Scientists and public health officials have sought to reduce the incidence of human infections from pathogenic bacteria such as Salmonella and Escherichia coli (“E. coli”). Food products are a significant source of human infection by pathogens. Animal food products may become contaminated with bacterial food-borne pathogens as a result of exposure of the animal carcass to fecal matter. Likewise, fruits and vegetables may become contaminated by contact with pathogenic bacteria. The pathogens are then transmitted to humans during consumption of the contaminated food.

Anderson et al. in U.S. Pat. No. 6,761,911, the disclosure of which is incorporated by reference, disclose the use of feeding chlorate to livestock during the last few weeks prior to harvest of the animals thereby reducing E. coli and Salmonella in the gastrointestinal tract of the animals.

Some pathogenic bacteria such as E. coli and Salmonella have the enzyme “nitrate reductase”. That enzyme enables those pathogens to derive energy from converting nitrate to nitrite inside the cell. These pathogens also internalize chlorate, which is chemically similar to nitrate, and the same enzyme, nitrate reductase, converts chlorate to chlorite which is toxic to these pathogens. In this manner, chlorate is selective to certain classes of pathogens because the enzyme nitrate reductase is generally present in only pathogenic bacteria.

A need, however, exists for improved methods for controlling pathogenic bacteria on food products.

### BRIEF DESCRIPTION OF THE DRAWINGS

For the present invention to be clearly understood and readily practiced, the present invention will be described in conjunction with the following figures, wherein like reference characters designate the same or similar elements, which figures are incorporated into and constitute a part of the specification, wherein:

FIG. 1 shows the effect of chlorate on Salmonella in chicken;

FIG. 2 displays the effect of chlorate on Salmonella in spinach;

FIG. 3 shows the effect of chlorate on Salmonella in apples; and

FIG. 4 displays the effect of chlorate on Salmonella in rough-cut oak boards.

### SUMMARY OF THE INVENTION

In accordance with at least one embodiment of the invention, the invention relates to processes and formulations using chlorate for the control of pathogenic bacteria in food and livestock. In a preferred embodiment, the formulation includes sodium chlorate in a concentration effective to reduce and inhibit the growth of E. coli and Salmonella on an object.

In the invention, the sodium chlorate formulation may be employed as a rinsing/washing agent. In exemplary embodiments of the invention, the sodium chlorate formulation is used to wash fruits and vegetables, poultry products and livestock facilities. The concentrations of chlorate currently contemplated by the invention are not generally toxic to other bacteria or the host animal.

### DETAILED DESCRIPTION OF THE INVENTION

It is to be understood that the descriptions of the invention have been simplified to illustrate elements that are relevant for a clear understanding of the invention, while eliminating, for purposes of clarity, other elements that may be well known. Those of ordinary skill in the art will recognize that other elements are desirable and/or required in order to implement the invention. However, because such elements are well known in the art, and because they do not facilitate a better understanding of the invention, a discussion of such elements is not provided herein.

As used herein, the term “object” refers to something material that can be perceived with the senses, directly and/or indirectly. Objects include surfaces such as hard or soft surfaces and the like.

Objects include food products such as fruits and vegetables and poultry products. Objects also include livestock and poultry housing facilities (and their surfaces) such as barns, stalls, holding facilities, pens and trucks.

In accordance with at least one embodiment of the invention, chlorate is used as a rinsing/washing agent for the control of pathogenic bacteria in food and livestock. In exemplary embodiments of the invention, the sodium chlorate formulation is used to wash objects such as fruits and vegetables, poultry products and livestock facilities. In at least one embodiment, the formulation includes sodium chlorate in a concentration effective against E. coli and Salmonella.

In at least one embodiment, the formulation includes an effective amount of sodium chlorate in a concentration between about 0.01% and about 30.0% in a solution with water. The effective temperature range is between about 30° and about 130° F., with highest efficacy in the ranges of between about 70° and about 120° F.

Effective product contact time is at least about 30 minutes for and could be as much as 6 hours, depending on pathogen concentrations and temperature conditions.

In a first embodiment, a solution containing an effective amount of sodium chlorate is used as a disinfectant/bacteriocide for livestock and poultry housing and transportation facilities to significantly reduce or eliminate pathogens Salmonella and E. coli and prevent their growth. Frequently animals are contaminated from pathogens in their environment and this is transferred to the meat later consumed by humans. A solution containing an effective amount of sodium chlorate is applied to agricultural objects such as barns, stalls, holding facilities, pens and trucks: any place that might harbor these pathogens and have the opportunity to contaminate the hair, skin or feathers of animals produced for human food. The solution is applied in a known manner such as spraying or immersion. The application of the solution of the invention reduces the opportunity for the spread of pathogens that infect animals and cause illness including those that effect young animals such as calves, pigs, lambs and poults.

In another embodiment, a solution containing an effective amount of sodium chlorate is used as a disinfectant/bacteriocide in poultry processing. It is well established that Salmonella in poultry is common, as many as 80% of poultry carcasses have shown to be contaminated. According to this embodiment a solution containing an effective amount of sodium chlorate is used in scald water and/or chill water, in order to reduce/eliminate the Salmonella and E. coli that might contaminate the poultry meat.

In another embodiment, a solution containing an effective amount of sodium chlorate is used as a disinfectant/bacteriocide for fresh fruits and vegetables for reducing/eliminating contamination from pathogens, especially Salmonella and E. coli. Used as a wash and rinse for produce, the solution of the invention effects the metabolism of the indicated pathogens and effectively eliminate them. The contact time is preferably between about 4 and about 6 hours. As an example, the solution according to the invention is applied to fruits such as apples to be made into cider, thus, no longer requiring pasteurization to produce safe products. For vegetables, the methods of the invention may include mist spraying lettuce at harvest. The crops may then be soaked and rinsed a few hours later for approximately 30 minute to 1 hour to remove the chlorate solution. The delay between the initial exposure and the rinsing provides an adequate contact time between the chlorate formulation and the produce. The actual production applications could be suited to the type of product and the production practices in place.

The present invention may be better understood in light of the following examples. In each example, data were analyzed with STATISTIX FOR WINDOWS 8.0 using Analysis of Variance for a completely randomized experimental design, Bartlett's Test of Equal Variances, and Tukey's procedure for mean separation.

### EXAMPLE 1

Eight chicken backs were inoculated with Salmonella (TNTC inoculum). After 20 minutes, four were sprayed with a 10% solution (w/w) of sodium chlorate and water and the other four were sprayed with an equal amount of distilled water. Swabs of approximately 100 cm² were taken after 4 hours on four backs treated with sodium chlorate solution and swabs of approximately 100 cm² were taken after 72 hours on both the sodium chlorate solution and distilled water-treated backs and enumerated for Salmonella counts.

Treatment with sodium chlorate solution significantly reduced (P<0.001) the number of Salmonella on chicken backs at both 4 and 72 hours post-treatment compared with controls. There was no difference (P>0.10) in Salmonella counts between the 4 and 72 hour treatments. At 4 hours post-treatment, Salmonella counts were 143,750±112,263 (mean ±standard error) and at 72 hours were 377,500±140,453. At 72 hours, the control chicken had Salmonella counts of 6,500,000±1,424,000.

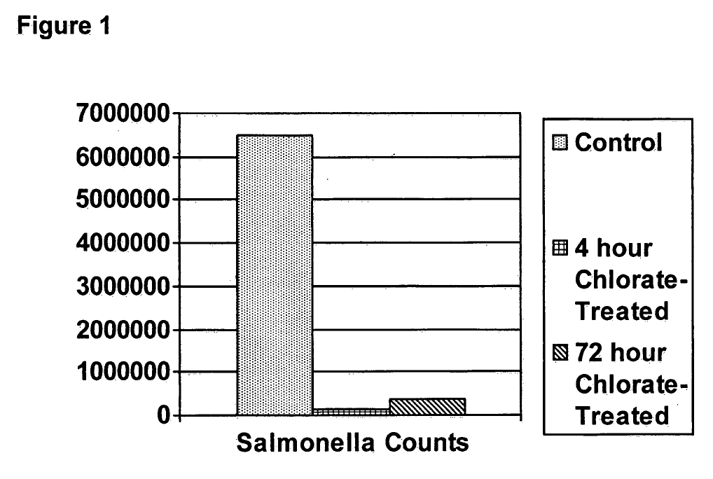

The data for Example 1 are displayed in FIG. 1.

### EXAMPLE 2

Sixteen baby spinach leaves were inoculated with Salmonella (TNTC inoculum). Sixty minutes later, eight leaves were immersed in 10% solution (w/w) of sodium chlorate and water for five minutes while the other eight leaves served as controls. Both treated and control leaves were then washed with distilled water.

After 72 hours, sponge samples were taken of 100 cm² and enumerated for Salmonella counts.

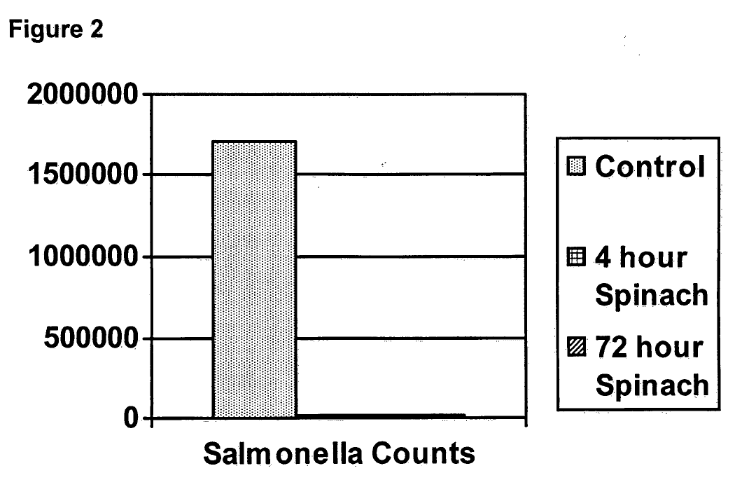

Treatment with chlorate significantly reduced (P<0.001) the number of Salmonella on baby spinach at both 4 and 72 hours post-treatment compared with controls. There was no difference (P>0.10) in Salmonella counts between the 4 and 72 hour treatments. At 4 hours post-treatment, Salmonella counts were 20,500±2,179 (mean ±standard error) and at 72 hours were 21,250±8,045. At 72 hours, the control baby spinach had Salmonella counts of 1,700,000±176,947. The data for Example 2 are displayed in FIG. 2.

### EXAMPLE 3

Eight apples (4 each of 2 varieties) were inoculated with Salmonella (TNTC inoculum). Sixty minutes later, two apples of each variety were soaked in 10% solution (w/w) of sodium chlorate and water for 30 minutes at 60° F. Both treated and untreated apples were then washed with distilled water. After 72 hours, sponge samples were taken of 100 cm² and enumerated for Salmonella counts.

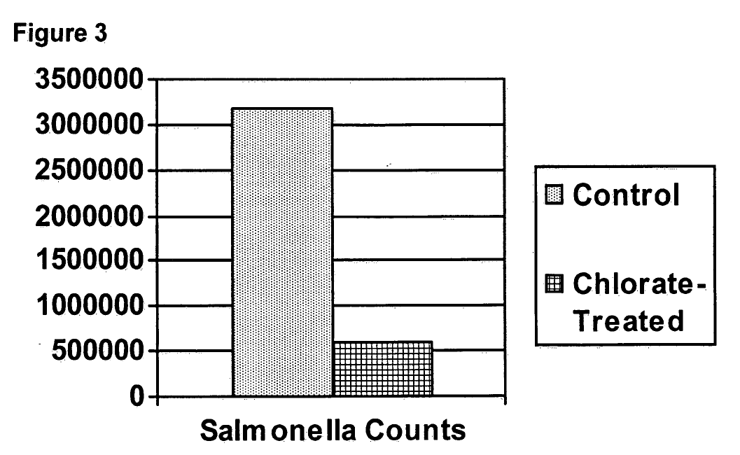

Treatment with chlorate tended to reduce (P=0.127) the number of Salmonella on apples at 72 hours post-treatment compared with controls. At 72 hours post-treatment, Salmonella counts were 585,250±88,507 (mean ±standard error) compared with control apples which had Salmonella counts of 3,190,000±1,470,000. Variance of treated apples was significantly lower (P<0.001) than variance of control apples. Examination of these data revealed that the wide variance of the control apples was due to one extremely high control apple which accounted for the lack of significant differences between treated and control apples. Data for Example 3 are shown in FIG. 3.

### EXAMPLE 4

Thirteen rough-cut oak boards were used to test effectiveness of chlorate in reducing Salmonella in livestock facilities. Two boards were pre-treated by spraying with 10% solution (w/w) of sodium chlorate and water for 2 days prior to inoculation with Salmonella. Three boards were pre-treated by spraying with 10% solution (w/w) of sodium chlorate and water for 2 days prior to inoculation with Salmonella and then treated by spraying with 10% solution (w/w) of sodium chlorate and water after inoculation with Salmonella. Four boards were treated by spraying with 10% solution (w/w) of sodium chlorate and water after inoculation with Salmonella. Four boards were also inoculated with Salmonella and served as controls. After 72 hours, sponge samples were taken of 100 cm² and enumerated for Salmonella counts from all boards.

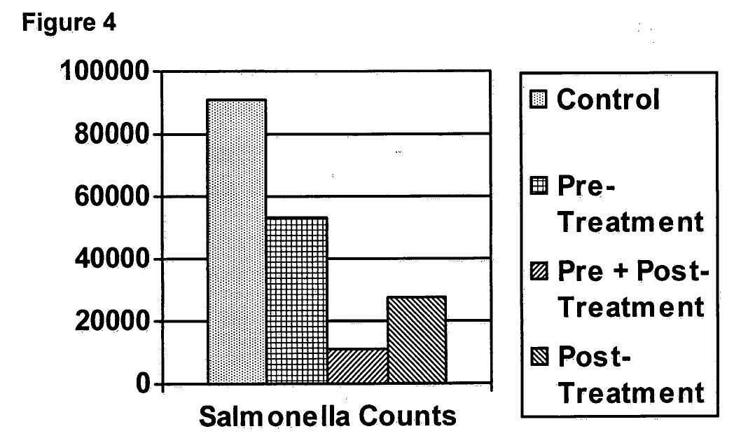

Treatment with chlorate tended to reduce (P>0.10) the number of Salmonella on rough-cut oak boards compared with controls. Rough-cut oak boards that were pre-treated with chlorate had Salmonella counts of 53,500±44,508 (mean ±standard error). Rough-cut oak boards that were pre-treated and post-treated with chlorate solution had Salmonella counts of 11,169±36,341. Rough-cut oak boards that were treated with chlorate solution after inoculation had Salmonella counts of 28,000±31,472. By comparison, control boards had Salmonella counts of 90,125±31,472. Although Salmonella counts of the treated boards were 59.4% (pre-treated), 12.4 (pre+ post-treated), and 31.1% (post-treated) of the control boards, these reductions in Salmonella counts were not statistically significant due to the high variability among treatments. Also, it should be recognized that Salmonella counts in all the rough-cut oak boards were lower than in chicken, baby spinach, and apples which is most likely an indication that the boards were not as favorable of a media as the chicken, baby spinach, and apples used in our experiments. Data from Example 4 are displayed in FIG. 4.

Nothing in the above description is meant to limit the invention to any specific materials, geometry, or orientation of elements. Many part/orientation substitutions are contemplated within the scope of the invention and will be apparent to those skilled in the art. The embodiments described herein were presented by way of example only and should not be used to limit the scope of the invention.

Although the invention has been described in terms of particular embodiments in an application, one of ordinary skill in the art, in light of the teachings herein, can generate additional embodiments and modifications without departing from the spirit of, or exceeding the scope of, the claimed invention.

Accordingly, it is understood that the drawings and the descriptions herein are proffered only to facilitate comprehension of the invention and should not be construed to limit the scope thereof.

What is claimed is:

1. A method for controlling pathogenic bacteria on an object comprising:
surface treating an object with a solution comprising chlorate in an amount effective to reduce and inhibit the growth of pathogenic bacteria on the object.

2. The method of claim 1, wherein the chlorate is sodium chlorate.

3. The method of claim 1, wherein the effective amount of sodium chlorate is between about 0.01% and about 30.0% of the solution.

4. The method of claim 1, wherein in the object is a food product.

5. The method of claim 4, wherein in the food product is one of a fruit and a vegetable.

6. The method of claim 4, wherein in the food product is poultry.

7. The method of claim 6, wherein the poultry is treated with the solution during at least one of an application of a scald water and a chill water.

8. The method of claim 1, wherein in the object is one of a livestock and poultry housing facility.

9. The method of claim 1, wherein the surface treating step is for a period of between about 30 minutes to about 6 hours.

10. The method of claim 1, wherein the surface treating step includes rinsing the object with the solution.

11. The method of claim 1, wherein the surface treating step includes misting the object with the solution.

12. The method of claim 1, wherein the surface treating step includes soaking the object in the solution.

13. The method of claim 1, wherein the pathogenic bacteria are at least one of E. coli and Salmonella.
